(19) United States
(12) Patent Application Publication
(10) Pub. No.: US 2016/0168029 A1
(43) Pub. Date: Jun. 16, 2016

(54) ADDITIVE SYSTEM INCLUDING A POLYALKOXYLATED PHOSPHONATE, A POLYALKOXYLATED POLYCARBOXYLATE AND A RETARDING AGENT, AND USE THEREOF

(71) Applicant: CHRYSO, Issy Les Moulineaux (FR)

(72) Inventors: Amjad MALLAT, Puiseaux (FR); Alexandre PINEAUD, Malesherbes (FR)

(21) Appl. No.: 14/888,671

(22) PCT Filed: May 2, 2014
(86) PCT No.: PCT/EP2014/058992

§ 371 Date: Nov. 2, 2015

(30) Foreign Application Priority Data
May 3, 2013 (FR) 1354090

(51) Int. Cl. C04B 24/24; C04B 24/10; C04B 28/04; C04B 24/26

(52) U.S. Cl. CPC C04B 24/246; C04B 24/2647; C04B 24/10; C04B 28/04

(57) ABSTRACT

The disclosure relates to an additive system for a hydraulic composition including: at least one polyalkoxylated phosphonate polymer; at least one polyalkoxylated polycarboxylate polymer; and at least one retarding agent of formula (I): C¹R′H(OH)[CH(OH)]nC(O)O¹R (I) for improved maintenance of the rheology of hydraulic compositions of Portland cement.

### FIELD OF THE INVENTION

The present invention relates to an admixture system for a hydraulic composition and its use to improve the maintenance of the rheology of hydraulic compositions, and more particularly hydraulic compositions of Portland cement.

### BACKGROUND OF THE INVENTION

Hydraulic compositions are compositions comprising a hydraulic binder, i.e., a compound having the property of hydrating in the presence of water and whose hydration makes it possible to obtain a solid having mechanical resistance characteristics. Hydraulic compositions are for example concrete, screed or mortar.

It is known to add thinners (also called plasticizers or superplasticizers) that make it possible to thin the hydraulic composition and thus decrease the water content of the hydraulic binder paste in order in particular to obtain higher mechanical strengths. These thinners also provide maintenance of the rheology, thus allowing stabilization of the hydraulic binder composition over a longer length of time before it hardens and sets.

In particular known from FR 2,696,736 are polyalkoxylated phosphonates described as providing exceptional water reduction and fluidity maintenance properties over time (also called maintenance of rheology or maintenance of workability).

Also known from FR 2,893,038 are hydraulic binder compositions comprising high alumina cement (comprising aluminates) and a retarder and a superplasticizer. The addition of a retarder in such a system is not problematic, since the aluminates that are present play an accelerator role therefore making it possible to obtain mechanical strengths quickly.

In order to obtain improved properties, in particular in terms of water reduction and maintenance of rheology, while retaining good viscosity properties and reducing costs, admixtures have been proposed (FR 2,776,285, WO 2011/015781) comprising, in mixture, at least one polyalkoxylated phosphonate and at least one second superplasticizer of the polyalkoxylated polycarboxylate type.

There is still an interest in providing admixture systems making it possible to improve the fluidity maintenance of a hydraulic composition, in particular while decreasing the cost of such admixture use.

### SUMMARY OF THE INVENTION

One aim of the present invention is therefore to provide an admixture system making it possible to improve the maintenance of fluidity of a hydraulic composition, in particular of Portland cement, in particular at a reduced cost.

Another aim of the present invention is to provide an admixture system making it possible to improve the maintenance of fluidity in a hydraulic composition over a significant length of time. In particular, one of the aims of the present invention is to provide an admixture making it possible to have a fluidity maintenance over a duration greater than or equal to 90 minutes, for example 240 to 300 minutes, in particular greater than 300 minutes. Another aim of the present invention is to propose a method making it possible to limit the polyalkoxylated phosphonate assay in the admixture s while improving maintenance of the fluidity of a hydraulic composition.

Still other aims will appear upon reading the following description of the invention.

These aims are met by the present invention, which proposes an admixture system for a hydraulic composition, comprising:
at least one polyalkoxylated phosphonate polymer;
at least one polyalkoxylated polycarboxylate polymer; and
at least one setting retarder of formula (I):

C¹R′H(OH)[CH(OH)]ₙC(O)O¹R (I)

wherein

R′ represents H;

R represents H, an ammonium, an amine group or an alkali or alkaline-earth metal; or R and R′ are absent and C¹ and O¹ are connected by a covalent bond so as to form a polyhydroxylactone cycle n represents an integer comprised between 2 and 6, for example 4 or 5.

In one particular embodiment, the setting retarder is a setting retarder with formula (I):

C¹R′H(OH)[CH(OH)]ₙC(O)O¹R (I)

wherein

R′ represents H;

R represents H, an ammonium, an amine group or an alkali or alkaline-earth metal

n represents an integer comprised between 2 and 6, for example 4 or 5.

Preferably in this embodiment, n represents 4 or 5, preferably 4.

In another embodiment, the setting retarder is a compound of formula (la):

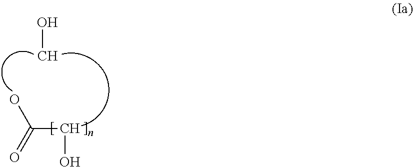

wherein n represents an integer comprised between 2 and 6, for example 4 or 5.

### DETAILED DESCRIPTION OF CERTAIN EMBODIMENTS

In the context of the present invention, a hydraulic composition refers to a composition comprising a hydraulic binder. For example, a hydraulic composition refers to a composition comprising a hydraulic binder, optionally an aggregate, a mineral addition, water, an additive (such as a superplasticizer, an anti-foaming additive, an air-entraining additive, a plasticizer or a thinner).

In the context of the present invention, the hydraulic compositions are for example concrete, mortar or screed compositions.

“Aggregate” refers to a set of mineral grains with an average diameter comprised between 0 and 125 mm. Depending on their diameter, the aggregates are classified in one of the six following families: fillers, fine sands, sands, gravels, crushed stone and ballast (standard XP P 18-545). The most widely used aggregates are the following:
fillers, which have a diameter smaller than 2 mm and for which at least 85% of the aggregates have a diameter smaller than 1.25 mm and at least 70% of the aggregates have a diameter smaller than 0.063 mm,
sands, with a diameter comprised between 0 and 4 mm (standard 13-242, the diameter being able to reach up to 6 mm),
gravels, with a diameter greater than 6.3 mm,
crushed rocks, with a diameter comprised between 2 mm and 63 mm.

Sands are therefore comprised in the definition of aggregate according to the invention. The fillers may in particular be of limestone or dolomitic origin.

“Hydraulic binder” refers to any compound having the property of hydrating in the presence of water and whose hydration makes it possible to obtain a solid having mechanical characteristics, in particular a cement such as Portland cement, pozzolanic cement or an anhydrous or semi-hydrated calcium sulfate. The hydraulic binder may be a cement according to standard EN 197-1 (2001), and in particular a Portland cement, mineral additions, in particular slag, or a cement comprising mineral additions.

“Cement”, and in particular “Portland cement”, refers to a cement according to standard EN 197-1 (2001), and in particular a cement of type CEM I, CEM II, CEM III, CEM IV or CEM V according to Cement standard NF EN 197-1 (2001). The cement, and in particular Portland cement as defined in standard EN 197-1 (2001), may comprise mineral additions.

“Mineral additions” refers to slags (as defined in the Cement standard NF EN 197-1(2001) paragraph 5.2.2), slag from steel mills, pozzolanic materials (as defined in Cement standard NF EN 197-1(2001) paragraph 5.2.3), fly ash (as defined in the Cement standard NF EN 197-1(2001) paragraph 5.2.4), burnt shales (as defined in the Cement standard NF EN 197-1(2001) paragraph 5.2.5), limestones (as defined in the Cement standard NF EN 197-1(2001) paragraph 5.2.6) or silica fumes (as defined in the Cement standard NF EN 197-1(2001) paragraph 5.2.7), or mixtures thereof. Other additions, not currently recognized by Cement standard NF EN 197-1(2001), can also be used. These in particular involve metakaolins, such as type A metakaolins according to standard NF P 18-513 (August 2012), and siliceous additions, such as siliceous additions of Qz mineralogy according to standard 18-509 (September 2012).

Preferably, the hydraulic compositions according to the invention are Portland cement compositions as defined in standard EN 197-1 (2001). The Portland cement compositions according to the invention may further comprise mineral additions as defined above, in particular with the exception of aluminate.

The invention more particularly covers the use of said admixture system as a thinner for hydraulic compositions of Portland cement, in particular to improve the maintenance of fluidity of these hydraulic compositions over time, in particular in the long term, and in particular over durations greater than or equal to 90 minutes, preferably between 240 and 300 minutes, in particular greater than 300 minutes.

In the context of the present invention, the polyalkoxylated polycarboxylate polymer is preferably a comb polymer comprising a skeleton and side chains including the following patterns (III) and (IV):

*—R1-(C(O))ₘ—R2-(Alk-O)ₙ—R3 (III)

where * designates the attachment point to the skeleton of the comb polymer, R1 is a chemical bond or alkylene group of 1 to 8 carbon atoms, m is equal to 0 or 1, R2 designate an oxygen atom or an amine group, Alk designates alkylene with 2 to 4 carbon atoms, linear or branched, n designates an integer comprised between 3 and 500, a same polymer being able to bear grafts with different lengths, and R3 designates a hydrogen atom or a hydrocarbon group such as an alkyl including 1 to 25 carbon atoms.

*—R4 (IV)

where R4 comprises an acid and/or dissociated anionic function.

A superplasticizer of the comb polymer type also refers to the superplasticizers obtained by mixing different polymers including side chains of type (I) and (II).

In the context of the present invention, the polyalkoxylated phosphonate polymer is preferably a polyalkoxylated phosphonate with formula (V) or one of its salts, alone or in a mixture:

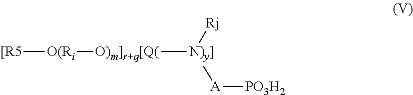

wherein:

R5 is a hydrogen atom or monovalent hydrocarbon group including from 1 to 18 carbon atoms and optionally one or more heteroatoms;

the Rⁱ are similar to or different from one another and represent an alkylene such as ethylene, propylene, butylene, amylene, octylene or cyclohexene, or an arylene such as styrene or methylstyrene, the Rᵢ optionally containing one or more heteroatoms;

Q is a hydrocarbon group including 2 to 18 carbon atoms and optionally one or more heteroatoms;

A is an alkylidene group including 1 to 5 carbon atoms;

the Rᵢ are similar to or different from one another and can be chosen from among:
the A-PO₃H₂ group, A having the aforementioned meaning,
the alkyl group including 1 to 18 carbon atoms and able to bear [R5-O(Rᵢ-O)ₘ] groups, R5 and Rᵢ having the aforementioned meanings,
   “m” is a number greater than or equal to 0,
   “r” is the number of groups [R⁵—O(Rᵢ-O)ₘ] carried by the set of Rj,
   “q” is the number of groups [R⁵—O(RᵢO)ₘ] carried by Q, the sum
   “r+q” is comprised between 1 and 10,
   “y” is an integer comprised between 1 and 3,
   Q, N and the R, can form one or more cycles together, this or these cycles further being able to contain one or more other heteroatoms.

Particularly preferably, the polyalkoxylated phosphonate is made up of a hydrosoluble or hydrodispersible organic compound including at least one amino-di-(alkylene phosphonic) group and at least one polyoxyalklyated chain or at least one of its salts.

Preferably, the polyalkoxylated phosphonate is a compound with formula (V) in which:

R⁵ is a hydrogen atom or a monovalent hydrocarbon group, saturated or not, including 1 to 8 carbon atoms and optionally one or more heteroatoms;

the Rᵢ represent ethylene or propylene or a mixture of ethylene or propylene, preferably 60 to 100% of the Rᵢ are ethylene groups;

Q is a hydrocarbon group including 2 to 8 carbon atoms and, optionally, one or more heteroatoms;

A is the methylene group;

each of the Rⱼ represents the CH₂—PO₃H₂ group;

m is an integer comprised between 10 and 250;

q is in integer greater than or equal to 1 or 2;

y is in integer equal to 1 or 2.

In particular, the polyalkoxylated phosphonate can be a polyalkoxylated phosphonate of formula (V) in which R5 is a methyl group, the Rᵢ are ethylene and propylene groups, m being comprised between 30 and 50, r+q is equal to 1, Q is an ethylene group, A is a methylene group, y is equal to 1 and R, corresponds to the CH₂-PO₃H₂ group.

Preferably, the retarder is chosen from among gluconic acid and its salts, in particular alkali salts, for example sodium, lithium or potassium, ammonium or amine group.

The system according to the invention preferably comprises, by dry weight relative to the total binder weight, 0.03 to 1% of polyalkoxylated phosphonate, 0.03 to 1% of polyalkoxylated polycarboxylate and 0.03 to 0.3% of retarder of formula (I). In the context of the present invention, total binder refers to the sum of the masses of cement, preferably Portland cement, mineral additions and fillers. The fillers may in particular be of limestone, siliceous or dolomitic origin.

The system according to the invention preferably comprises, in dry weight relative to the total binder weight, preferably relative to the weight of Portland cement and any mineral additions as defined above, 0.09 to 0.65%, preferably 0.09 to 0.35% of polyalkoxylated phosphonate, 0.09 to 0.35% of polyalkoxylated polycarboxylate and 0.06 to 0.24% of retarder of formula (I).

Particularly advantageously, the inventors have shown that the particular choice of a retarder of formula (I), in particular in the aforementioned proportions, added to an admixture system comprising at least one polyalkoxylated polycarboxylate and at least one polyalkoxylated phosphonate makes it possible to improve the maintenance of fluidity (maintenance of rheology), in particular over the long term, in particular over durations greater than or equal to 90 minutes, preferably between 240 and 300 minutes, in particular greater than 300 minutes, relative to other retarders known by those skilled in the art. Indeed, as shown by the examples of the present invention, retarders of formula (I) compared to the other retarders known by those skilled in the art advantageously make it possible, combined with a polyalkoxylated phosphonate and a polyalkoxylated polycarboxylate, to obtain a hydraulic composition, preferably Portland cement, with maintenance of rheology in particular over durations greater than or equal to 90 minutes, preferably between 240 and 300 minutes, preferably greater than 300 minutes.

Particularly advantageously, the inventors have shown that replacing part of the polyalkoxylated polycarboxylate or part of the polyalkoxylated phosphonate, in particular part of the polyalkoxylated phosphonate, with an equivalent quantity of retarder of formula (I), in particular in the aforementioned proportions, in a system comprising at least one polyalkoxylated polycarboxylate and at least one polyalkoxylated phosphonate makes it possible to improve the maintenance of fluidity (maintenance of rheology or maintenance of workability) in particular over the long term, in particular over durations greater than or equal to 90 minutes, preferably between 240 and 300 minutes, in particular greater than 300 minutes.

The admixture system of the present invention may further comprise additives of the air-entraining additive type and/or anti-foaming additives.

A system made up of the three components described above, excluding other additives, or at least additives that may affect workability and early resistance, for example excluding aluminate, is particularly preferred.

The invention also relates to a method for preparing the admixture system according to the invention comprising the step of mixing at least one polyalkoxylated polycarboxylate, at least one polyalkoxylated phosphonate and a retarder of formula (I).

The invention also relates to a method for preparing hydraulic compositions, preferably Portland cement, in particular concrete, mortar or screed, comprising the step of adding, in appropriate quantities, respectively:
(a) a polyalkoxylated polycarboxylate;
(b) a polyalkoxylated phosphonate; and
(c) a retarder of formula (I),

simultaneously or successively, preferably simultaneously, to a hydraulic binder paste, preferably Portland cement, during mixing. The admixture system according to the invention is consequently added in the mixing water.

The polyalkoxylated polycarboxylate, the polyalkoxylated phosphonate and the retarder of formula (I) are as defined above.

The invention also relates to a method for preparing hydraulic compositions, preferably Portland cement, in particular concrete, mortar or screed, comprising the step of adding, in appropriate quantities, respectively:
(a) a polyalkoxylated polycarboxylate;
(b) a polyalkoxylated phosphonate; and
(c) a retarder of formula (I),

simultaneously or successively, to the solid components of the hydraulic composition, preferably Portland cement, in particular to the hydraulic binder, preferably Portland cement, or to the sand.

The polyalkoxylated polycarboxylate, the polyalkoxylated phosphonate and the retarder of formula (I) are as defined above.

The invention also relates to a method for preparing hydraulic compositions, preferably Portland cement, comprising the step of mixing:
an admixture system according to the invention;
at least one hydraulic binder, preferably Portland cement;
sand;
optionally at least one aggregate;
water,
   the components of the hydraulic composition being added in any order and the components of the admixture system being added simultaneously or successively with respect to the water, to the hydraulic binder, preferably Portland cement, the sand and/or the aggregate making up the hydraulic composition.

The invention also relates to a hydraulic composition, preferably Portland cement, comprising an admixture system according to the invention.

The invention also relates to the use of the admixture system described for the preparation of hydraulic compositions, preferably Portland cement.

Advantageously, the admixture system is added to the hydraulic composition during mixing, preferably by adding to the mixing water. Alternatively, the admixture can be added to the solid components of the hydraulic composition, in particular to the hydraulic binder, preferably Portland cement, and/or to the sand.

Of course, other typical additives known by those skilled in the art can also be added to the concrete composition directly or by means of a component of the hydraulic composition (for example, by means of the admixture system according to the invention). Examples include air-entraining agents and anti-foaming agents.

The present invention also relates to the use of the admixture system as a thinner for hydraulic compositions, in particular Portland cement, in particular to improve the maintenance of fluidity (or maintenance of workability) of said hydraulic compositions over time, in particular in the long term, in particular over durations greater than or equal to 90 minutes, preferably between 240 and 300 minutes, in particular greater than 300 minutes.

Preferably, the invention relates to the use of an admixture system comprising, by dry weight relative to the total binder weight, in particular relative to the weight of Portland cement and any mineral additions, 0.03 to 1% of polyalkoxylated phosphonate, 0.03 to 1% of polyalkoxylated polycarboxylate and 0.03 to 0.3% of retarder of formula (I) as thinner for hydraulic compositions, in particular to improve the maintenance of fluidity (or maintenance of workability) of hydraulic compositions over time, in particular in the long term, in particular over durations greater than or equal to 90 minutes, preferably between 240 and 300 minutes, in particular greater than 300 minutes. Preferably, the invention relates to the use of an admixture system comprising, by dry weight relative to the total binder weight, 0.09 to 0,35% of polyalkoxylated phosphonate, 0.09 to 0,35% of polyalkoxylated polycarboxylate and 0.06 to 0.24% of retarder of formula (I) as thinner for hydraulic compositions, in particular to improve the maintenance of fluidity (or maintenance of workability) of hydraulic compositions over time, in particular in the long term, in particular over durations greater than or equal to 90 minutes, preferably between 240 and 300 minutes, in particular greater than 300 minutes.

The present invention also relates to a method for improving the maintenance of fluidity (or maintenance of workability) over time of a hydraulic composition, in particular Portland cement, comprising a step consisting of placing said hydraulic composition in contact with an admixture system according to the invention.

The present application will now be described using non-limiting examples.

The invention is illustrated in the following examples of preparations of hydraulic binder compositions of the mortar or concrete type.

The characterizations of the obtained hydraulic compositions (in particular maintenance of fluidity) are done using the Abrams cone by measuring the slump test for concretes and by measuring mortar spreading using the MCE (Mortar Concrete Equivalent) cone of 700 cm³, according to the CALIBE method described in “Results of Recommendations of the CALIBE National Project”, 2004 Edition: Presse de l'école nationale des Ponts et chaussees, Chapter 5, page 111: “La méthode MBE”.

The determination according to the Abrams cone method is done according to standard EN 12350-2 from 2012. The test consists of using freshly prepared concrete to fill a bottomless mold with a frustoconical shape with the following dimensions:

| | |
|---|---|
| diameter of the circle of the base greater than | 100 +/− 0.5 mm |
| diameter of the circle of the base less than | 200 +/− 0.5 mm |
| height | 300 +/− 0.5 mm |

The cone is raised vertically. The spreading is measured between 5 and 300 minutes according to four diameters at 45° with a sliding caliper. The result of the spreading measurement is the average of the four values at +/−10 mm. The tests are done at 20° C.

The admixture system is added to the hydraulic composition by the mixing water.

### EXAMPLE 1

The performance in terms of maintenance of rheology of an admixture system according to the invention was compared to that of an admixture system not comprising a retarder or comprising a different retarder from those of formula (I) for a concrete composition with the following formulation (the cement used is CEM I 52.5 N PMES CE CP2 NF Le HAVRE de LAFARGE) brought to 1 m³:

| | |
|---|---|
| Portland cement | 330 kg |
| Filler Millisil C10 | 60 kg |
| Condensil DM silica fume | 30 kg |
| Sand 0/1 R SEL SOIL | 120 kg |
| Sand 0/4 R SABCO | 685 kg |
| Gravel 4/10 C Montebourg | 200 kg |
| Gravel 10/20 C Montebourg | 785 kg |
| Total water | 173 kg |
| Effective water | 160 kg |

The mortar concrete equivalent was calculated based on this composition.

The concentrations of the admixtures are respectively expressed in percentage of dry extract relative to the total quantity of binder (cement+filler and/or cement additions).

The polyalkoxylated phosphonate (A) is the CHRYSO®Fluid Optima 100 marketed by the company CHRYSO.

The polyalkoxylated polycarboxylate (B) is a mixture of polyalkoxylated polycarboxylate marketed by the company CHRYSO.

The retarder (C) according to the invention is sodium gluconate.

The obtained results are shown in table 1 below:

CHR: polyol-type additive
CE: potassium phosphate-type additive
% loss: (value of the spreading or slump at 300 minutes—value of the spreading or slump at the initial T5)/value of the spreading or slump at initial T5

### M=Mortar

### C=Concrete

TABLE 1

| | | | | | | | Total | | | | | | | | | | | | |
|---|---|---|---|---|---|---|---|---|---|---|---|---|---|---|---|---|---|---|---|
| | | | | | | | admixture | 5 | 30 | 60 | 90 | 120 | 150 | 180 | 210 | 240 | 270 | 300 | % |
| Test | | A | B | C | CHR | CE | (%) | min | min | min | min | min | min | min | min | min | min | min | loss |
| | | | | | | | | Spreading (mm) | | | | | | | | | | | |
| 1 | M | 0.65 | 0.35 | | | | 1 | 390 | 390 | 390 | 390 | 400 | 400 | 380 | 355 | 335 | 325 | 300 | 23.1 |
| 2 | M | 0.59 | 0.35 | | | | 0.94 | 375 | 370 | 365 | 350 | 335 | 290 | 280 | 265 | 245 | 215 | 195 | 48 |
| 3 | M | 0.53 | 0.35 | | | | 0.88 | 360 | 355 | 355 | 325 | 300 | 260 | 250 | 235 | 215 | 200 | 180 | 50 |
| 4 | M | 0.35 | 0.35 | 0.2 | | | 0.9 | 350 | 380 | 380 | 380 | 390 | 400 | 375 | 365 | 355 | 335 | 315 | 10 |
| 5 | M | 0.35 | 0.35 | 0.16 | | | 0.86 | 305 | 315 | 315 | 310 | 300 | 280 | 270 | 260 | 255 | 250 | 245 | 19.7 |
| 6 | M | 0.35 | 0.35 | | 0.15 | | 0.85 | 300 | 315 | 305 | 295 | 270 | 270 | 250 | 235 | 220 | 205 | 195 | 35 |
| 7 | M | 0.35 | 0.35 | | | 0.25 | 0.95 | 240 | 250 | 240 | 230 | 200 | 190 | 185 | 170 | 160 | 150 | 140 | 41.7 |
| | | | | | | | | Slump (cm) | | | | | | | | | | | |
| 8 | C | 0.62 | 0.35 | | | | 0.97 | 23 | 23 | 23 | 23 | 22 | 21 | 20 | 18 | 16 | 14 | 13 | 43.5 |
| 9 | C | 0.35 | 0.35 | 0.24 | | | 0.94 | 16 | 21.5 | 21 | 20 | 18 | 17 | 18 | 18 | 15 | 15 | 15 | 9.4 |

These results show the impact of a retarder with formula (I) combined with a polyalkoxylated polycarboxylate and a polyalkoxylated phosphonate on the maintenance of rheology.

The comparison of tests 1 to 3 shows the decrease in the polyalkoxylated phosphonate assay causes a drop in the maintenance of rheology.

On the contrary, the comparison of tests 3 and 4 and tests 8 and 9 shows that a partial substitution of phosphonate by gluconate for an equivalent total additive assay allows a significant improvement in the maintenance of rheology. The spreading loss goes from 50 to 10% and from 43.5 to 9.4%.

The results also show that the increase of the gluconate assay results in an improvement in the plasticity and maintenance. The loss % goes from 19 to 10% (comparison of tests 4 and 5).

The results of the maintenance of rheology are lower performing with CHR relative to the gluconate (comparison of tests 5 and 6), which reflects the specificity of the gluconate combined with a polyalkoxylated polycarboxylate and a polyalkoxylated phosphonate on the rheology maintenance properties.

The rheology maintenance results are lower performing with CE relative to gluconate (comparison of tests 4 and 7), which reflects the specificity of the gluconate combined with a polyalkoxylated polycarboxylate and a polyalkoxylated phosphonate on the rheology maintenance properties.

### EXAMPLE 2

The performance in terms of maintenance of rheology of an admixture system according to the invention was compared to that of an admixture system not comprising a retarder or comprising a different retarder from those of formula (I) for a concrete composition with the following formulation (the cement used is CEM II/A-LL 42,5 R Couvrot de Calcia) brought to 1 m³:

| | |
|---|---|
| Cement | 280 kg |
| Sand 0/4 R Rosnay | 970 kg |
| Gravel 6.3/20 | 825 kg |
| Effective water | 160 kg |

The mortar concrete equivalent was calculated based on the following composition:

| | |
|---|---|
| Cement | 320 kg |
| Sand 0/4 R Rosnay | 885 kg |
| Gravel 6.3/20 | 995 kg |
| Effective water | 158 kg |

The obtained results are shown in table 2 below:

TABLE 2

| | | | | | Total dry | | | | | |
|---|---|---|---|---|---|---|---|---|---|---|
| | | | | | admixture | 5 | 30 | 60 | 90 | % |
| Test | | A | C | C | (%) | min | min | min | min | loss |
| | | | | | | Spreading (mm) | | | | |
| 10 | M | 0.24 | 0.24 | | 0.48 | 310 | 300 | 290 | 270 | 12.9 |
| 11 | M | 0.23 | 0.23 | 0.06 | 0.49 | 310 | 300 | 300 | 300 | 3.2 |
| | | | | | | Slump (cm) | | | | |
| 12 | C | 0.18 | 0.18 | | 0.36 | 17 | 15 | 15 | 4 | 76.5 |
| 13 | C | 0.16 | 0.16 | 0.06 | 0.38 | 18 | 19 | 17 | 17 | 5.6 |

% loss: (value of the spreading or slump at 90 minutes − value of the spreading or slump at the initial T5)/value of the spreading or slump at initial T5

The results show (comparison of tests 10 and 11 and tests 12 and 13) that an addition of gluconate with very low assay allows a significant improvement in the maintenance of rheology.

1. An additive system configured to thin a hydraulic composition, the additive system comprising:
at least one polyalkoxylated phosphonate polymer;
at least one polyalkoxylated polycarboxylate polymer; and
at least one setting retarder of formula (I):
C¹R′H(OH)[CH(OH)]ₙC(O)O¹R (I)
wherein
R′ represents H;
R represents H, an ammonium, an amine group or an alkali or alkaline-earth metal;
or R and R′ are missing and C¹ and O¹ are connected by a covalent bond so as to form a polyhydroxylactone cycle n represents an integer comprised between 2 and 6,
wherein the hydraulic composition comprises Portland cement, optionally mixed with mineral additions chosen from among slags, pozzolanic materials, fly ash, burnt shales, limestones, silica fumes, metakaolins, siliceous additions, or mixtures thereof, and
wherein, when the additive system is added to the hydraulic composition, fluidity of the hydraulic composition is maintained over durations greater than or equal to 90 minutes.

2. The additive system according to claim 1, wherein in the setting retarder of formula (I), R′ represents H and R represents H, an ammonium, an amine group or an alkali or alkaline-earth metal and n is equal to 4 or 5.

3. The additive system according to claim 1, wherein the setting retarder is selected from the group consisting of gluconic acid and a salt thereof.

4. The additive system according to claim 1, wherein the additive system comprises, by dry weight relative to the total binder weight, 0.03 to 1% of polyalkoxylated phosphonate, 0.03 to 1% of polyalkoxylated polycarboxylate and 0.03 to 0.3% of setting retarder of formula (I).

5. The additive system according to claim 1, wherein the additive system comprises, by dry weight relative to the total binder weight, 0.09 to 0.65% of polyalkoxylated phosphonate, 0.09 to 0.35% of polyalkoxylated polycarboxylate and 0.06 to 0.24% of setting retarder of formula (I).

6. The additive system according to claim 1, wherein the additive system comprises, by dry weight relative to the total binder weight, 0.09 to 0.35% of polyalkoxylated phosphonate, 0.09 to 0.35% of polyalkoxylated polycarboxylate and 0.06 to 0.24% of setting retarder of formula (I).

7. The additive system according to claim 1, wherein the polyalkoxylated polycarboxylate polymer is a comb polymer comprising a skeleton and side chains having the following patterns (III) and (IV):
*—R1-(C(O))ₘ—R2-(Alk-O)ₙR3 (III)
where * designates the attachment point to the skeleton of the comb polymer, R1 is a chemical bond or alkylene group of 1 to 8 carbon atoms, m is equal to 0 or 1, R2 designates an oxygen atom or an amine group, Alk designates alkylene with 2 to 4 carbon atoms, linear or branched, n designates an integer comprised between 3 and 500, a same polymer being able to bear grafts with different lengths, and R3 designates a hydrogen atom or a hydrocarbon group such as an alkyl including 1 to 25 carbon atoms
*—R4 (IV)
where R4 comprises an acid and/or dissociated anionic function.

8. The additive system according to claim 1, wherein the polyalkoxylated phosphonate polymer is a polyalkoxylated phosphonate of formula (V) or one of its salts, alone or in a mixture: 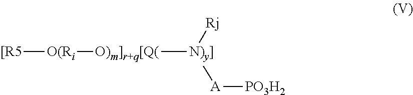
wherein:
R5 is a hydrogen atom or monovalent hydrocarbon group including from 1 to 18 carbon atoms and optionally one or more heteroatoms;
the Rᵢ are similar to or different from one another and represent an alkylene, or an arylene the Rᵢ optionally containing one or more heteroatoms;
Q is a hydrocarbon group including 2 to 18 carbon atoms and optionally one or more heteroatoms;
A is an alkylidene group including 1 to 5 carbon atoms;
the Rⱼ are similar to or different from one another and can be chosen from among:
the A-P0₃H₂ group, A having the aforementioned meaning,
the alkyl group including 1 to 18 carbon atoms and able to bear [R5-O(Rᵢ-O)ₘ] groups, R5 and Rᵢ having the aforementioned meanings,
“m” is a number greater than or equal to 0,
“r” is the number of groups [R⁵—O(Rᵢ-O)ₘ] carried by the set of Rj,
“q” is the number of groups [R⁵—O(RᵢO)ₘ] carried by Q, the sum
“r+q” is comprised between 1 and 10,
“y” is an integer comprised between 1 and 3,
Q, N and the Rⱼ can form one or more cycles together, this or these cycles further being able to contain one or more other heteroatoms.

9. The additive system according to claim 8, wherein:
R⁵ is a hydrogen atom or a monovalent hydrocarbon group, saturated or not, including 1 to 8 carbon atoms and optionally one or more heteroatoms;
the Rᵢ represent ethylene or propylene or a mixture of ethylene or propylene,
Q is a hydrocarbon group including 2 to 8 carbon atoms and, optionally, one or more heteroatoms;
A is the methylene group;
each of the Rⱼ represents the CH₂—PO₃H₂ group;
m is an integer comprised between 10 and 250;
q is in integer greater than or equal to 1 or 2;
y is in integer equal to 1 or 2.

10. The additive system according to claim 8, wherein R5 is a methyl group, the Rᵢ are ethylene and propylene groups, m being comprised between 30 and 50, r+q is equal to 1, Q is an ethylene group, A is a methylene group, y is equal to 1 and Rⱼ corresponds to the CH₂—PO₃H₂ group.

11. The additive system according to claim 1, further comprising additives of the air-entraining additive type and/or anti-foaming additives.

12. A method for preparing hydraulic compositions of Portland cement, comprising the step of adding the additive system according to claim 1 to Portland cement,
wherein the components of the additive system are added simultaneously or successively, to a Portland cement paste during mixing.

13. A method for preparing hydraulic compositions of Portland cement, comprising the step of adding the additive system according to claim 1 to Portland cement,
wherein the components of the additive system are added simultaneously or successively, to solid components of the hydraulic composition of Portland cement.

14. A method for preparing a hydraulic composition of Portland cement, comprising the step of mixing:
an additive system according to claim 1;
at least one Portland cement;
sand;
optionally at least one aggregate; and
water,
the components of the hydraulic composition being added in any order and the components of the additive system being added simultaneously or successively with respect to the water, the Portland cement, the sand and/or the aggregate making up the hydraulic composition.

15. A hydraulic composition made up of Portland cement, optionally mixed with mineral additions chosen from among slags, pozzolanic materials, fly ash, burnt shales, limestones, silica fumes, metakaolins, siliceous additions, or mixtures thereof, comprising an additive system according to claim 1.

16. The additive system according to claim 1, wherein n is an integer chosen from 4 or 5.

17. The additive system according to claim 3, wherein the salt is selected from the group consisting of sodium, lithium, potassium, ammonium or amine group.

18. The additive system according to claim 9, wherein 60 to 100% of the Rᵢ are ethylene groups.
